(19) United States
(12) Patent Application Publication
(10) Pub. No.: US 2023/0065472 A1
(43) Pub. Date: Mar. 2, 2023

(54) EXTENDING GRIPPING SOCKET SYSTEM

(71) Applicant: Darryl West, Berkley, CA (US)

(72) Inventor: Darryl West, Berkley, CA (US)

(21) Appl. No.: 17/412,276

(22) Filed: Aug. 26, 2021

(51) Int. Cl. H04M 1/04; H02J 7/35; H02J 50/10

(52) U.S. Cl. CPC H04M 1/04; H02J 7/35; H02J 50/10

(57) ABSTRACT

An extending gripping socket system includes an extending gripping socket attached to a base section. The extending gripping socket includes a semi-conical shape and is configured to extend and retract in relation to the base section. The base section includes a fastener section for securing the extending gripping socket system to a host electronic device. The base section further includes a charging port and an integrated wireless charger configured to provide power to and recharge the host electronic device. The extending gripping socket system provides wireless charging and an extendable hand grip for assisting a user with gripping and securely holding the host electronic device, such as a smartphone, during use.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of phone accessories of existing art and more specifically relates to phone gripping and charging accessories.

### RELATED ART

Smartphones are remarkably advanced, and very convenient to use. They aren't convenient to hold, however. Their odd shapes put them at risk while we hold them awkwardly in one hand and try to use them with the other. Hindering that convenience even more is the difficulty in keeping smartphones charged when we need them and where we need them. Wireless chargers don't address that in full because they leave smartphones unusable and in a single location during the charging process. A suitable solution is desirable.

U.S. Pat. No. 8,560,031 to David B. Barnett relates to an extending socket for portable media player. The described extending socket for portable media player includes extending sockets, formed of accordions generally with buttons attached at their distal ends, for attaching to portable media players or portable media player cases. Cases having attached sockets serve purposes beyond protection of the player, such as managing a headset, attaching to belts or the like, forming stand legs to prop the player at a desired angle, forming grips for gaming, forming a grip for securely holding and manipulating player with one hand, and forming extended legs for wedging players that are phones between the ear and shoulder. The sockets are structured to allow headset cords to be wound around the accordions when the sockets are extended, to prevent the cords from tangling. Space in an attached case may be provided so that the sockets may be partially or fully retracted with headphone cords wrapped around them to save space.

### SUMMARY OF THE INVENTION

In view of the foregoing disadvantages inherent in the known phone accessory art, the present disclosure provides a novel extending gripping socket system. The general purpose of the present disclosure, which will be described subsequently in greater detail, is to provide an extending gripping socket system.

An extending gripping socket system is disclosed herein. The extending gripping socket system may include an extending gripping socket attached to a base section. The extending gripping socket is preferably of a semi-conical shape and is configured to extend and retract in relation to the base section. The base section includes a fastener section positioned on a bottom plane of the base section which is configured to secure the extending gripping socket system to a host electronic device. The base section further includes a charging port and an integrated wireless charger configured to provide power to and recharge the host electronic device. The extending gripping socket system provides an extendable hand grip for assisting a user with gripping and securely holding the host electronic device, such as a smartphone, during use. Additionally, the extending gripping socket system provides wireless charging for the host electronic device.

A method of use is also disclosed herein including the following steps: step one, providing an extending gripping socket system including an extending gripping socket having a semi-conical shape and being configured to extend and retract in relation to a base section having a fastener section positioned on a bottom plane of the base section which is configured to secure the extending gripping socket system to a host electronic device, an integrated wireless charger configured to provide power to and recharge the host electronic device, and a charging port; step two, removing a removeable cover; step three, applying the fastener section to the host electronic device; step four, extending the extending gripping socket for gripping; and step five, optionally removing the extending gripping socket system from the host electronic device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an extending gripping socket system, constructed and operative according to the teachings of the present disclosure.

FIG. 1 is a perspective view of the extending gripping socket system during an ‘in-use’ extended condition, according to an embodiment of the disclosure.

FIG. 2 is a perspective view of the extending gripping socket system of FIG. 1 during an ‘in-use’ non-extended condition, according to an embodiment of the present disclosure.

FIG. 3 is a top perspective view of the extending gripping socket system of FIG. 1 in a non-extended condition, according to an embodiment of the present disclosure.

FIG. 4 is a perspective view of the extending gripping socket system of FIG. 1 in an extended condition, according to an embodiment of the present disclosure.

FIG. 5 is a bottom perspective view of the extending gripping socket system of FIG. 1, according to an embodiment of the present disclosure.

FIG. 6 is a flow diagram illustrating a method of use, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a phone accessory and more particularly to an extending gripping socket system as used to improve the gripping and charging of mobile devices.

Generally, the extending gripping socket system provides a wireless charging system for an electronic device comprising an extending gripping socket having an integrated wireless charger. The device is configured to be attached to an electronic device such as a smartphone. The unit provides a combination extendable hand grip and wireless charging solution. The socket may be extended to form a convenient hand grip for securely holding and manipulating a smartphone. In one embodiment, the extending socket features a charging port. In alternative embodiments, the wireless charging system may include a phone case having a built-in extending socket and wireless charger. The wireless charger of the extending gripping socket system provides nearly continuous charging to the battery of the host electronic device. The extending gripping socket system can also be used as an easel prop to maintain the hosting smartphone in an upright horizontal or vertical position, allowing the user to view the smartphone screen in a hands-free manner.

In a preferred embodiment, the extending gripping socket system is formed as a removable extending gripping socket, made of polycarbonate. A first endpoint includes a semi-conical shape with flat surface, and an opposing endpoint features a flat surface coated with a pressure-sensitive adhesive (PSA). The semi-conical end of the grip, forming half of the structural length of the devices, is ribbed and collapsible. The flat surface at its endpoint may feature indicia, decorative imaging, or the like. The opposite portion of the device hosts an internal inductive electromagnet within a base section. The electromagnetic is formed by a closed loop of magnetic copper coil in tightly-coupled format. The exterior bottom of this electromagnet portion of the structure hosts the PSA, and the PSA is protected by wax paper until use. Directly below the electromagnet, and at the forming point of said base section, is an electromagnetic transfuser. One charging port is featured on the base section.

The extending gripping socket system can be made in various shapes and sizes. The pressure-sensitive adhesive of the extending gripping socket system can be of various types and depths. The extending gripping socket system can be made of various materials of applicability, including but not limited to polycarbonate (PC), polyurethane (PU), thermoplastic polyurethane, acrylonitrile butadiene styrene (ABS), aluminum, and any combination of these and other materials. The extending gripping socket system may include a strategically-located solar panel to provide energy to the wireless recharger. The extending gripping socket system can be made in variations in which it includes a suction cup instead of pressure-sensitive adhesive as the applications means upon a smartphone.

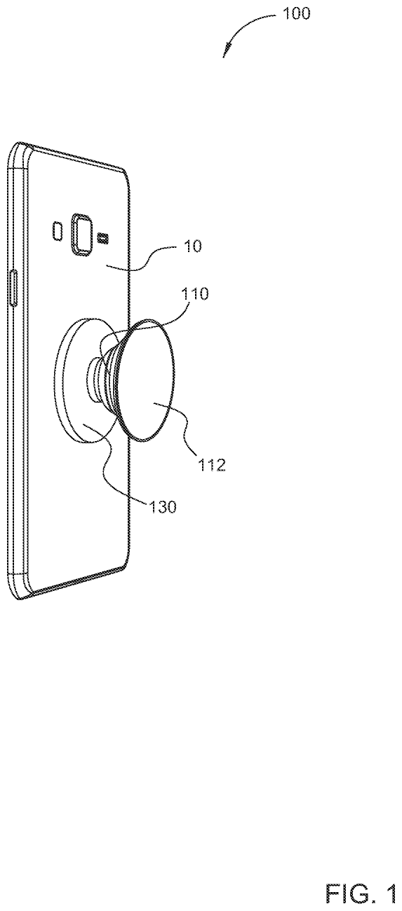

Referring now more specifically to the drawings by numerals of reference, there is shown in FIGS. 1-5, various views of an extending gripping socket system 100.

FIG. 1 is a perspective view of the extending gripping socket system 100 during an ‘in-use’ extended condition, according to an embodiment of the disclosure. Here, the extending gripping socket system 100 may be beneficial for use by a user to grip and wirelessly charge an electronic device 10 such as a smartphone. As illustrated, the extending gripping socket system 100 may include an extending gripping socket 110 attached to a base section 130. The extending gripping socket 110 includes a semi-conical shape and is configured to extend and retract in relation to the base section 130. The extending gripping socket system 100 provides an extendable hand grip for assisting a user with gripping and securely holding the host electronic device 10, such as a smartphone, during use.

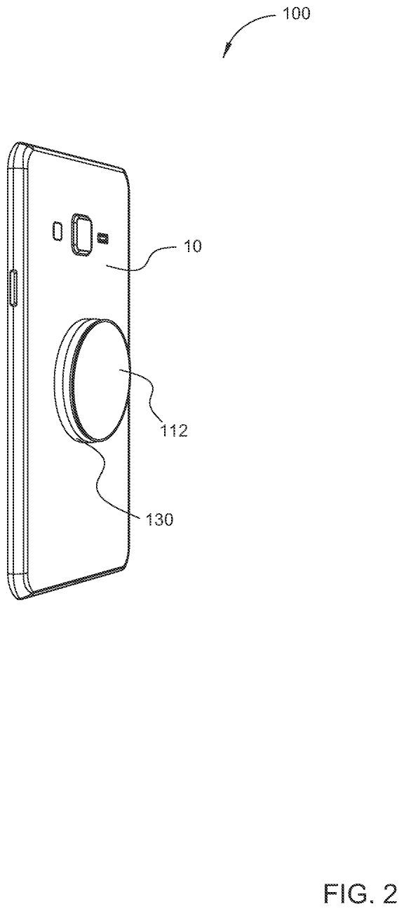

FIG. 2 is a perspective view of the extending gripping socket system 100 of FIG. 1 during an ‘in-use’ non-extended condition, according to an embodiment of the present disclosure. As shown, the extending gripping socket system 100 comprises the extending gripping socket 110 attached to the base section 130. The base section 130 includes a fastener section 132 positioned on a bottom plane 144 of the base section 130 which is configured to secure the extending gripping socket system 100 to a host electronic device 10. The base section 130 further includes a charging port 136 and an integrated wireless charger 138 configured to provide power to and recharge the host electronic device 10. In certain embodiments, the extending gripping socket system 100 may include a solar panel for providing power to the integrated wireless charger 138. In yet another embodiment, the extending gripping socket system 100 is provided as a phone case having an integrated the extending gripping socket 110 and the integrated wireless charger 138. The extending gripping socket system 100 allows users to hold a host electronic device 10 comfortably and securely.

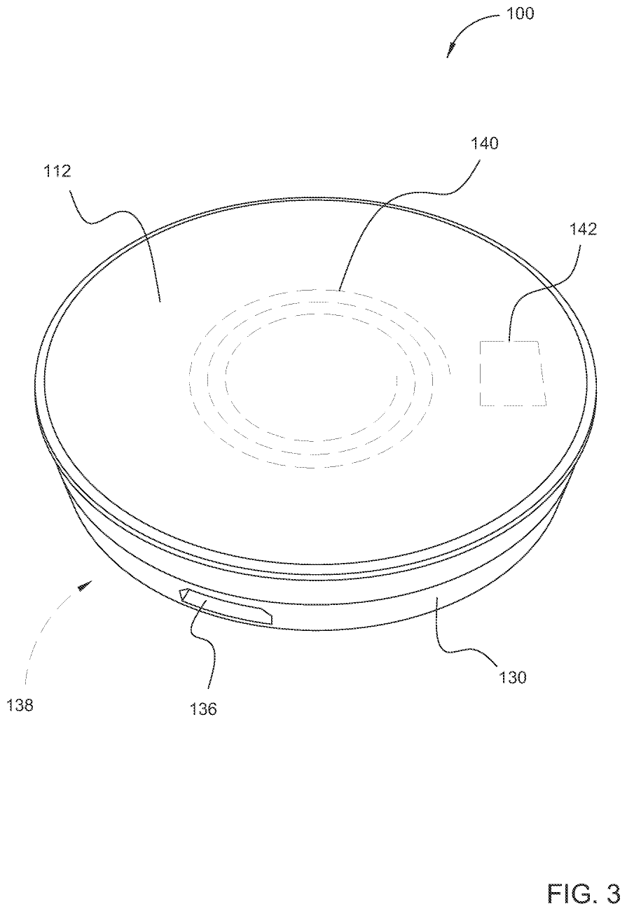

FIG. 3 is a top perspective view of the extending gripping socket system 100 of FIG. 1 in a non-extended condition, according to an embodiment of the present disclosure. As stated above, the base section 130 houses the integrated wireless charger 138 configured to provide power to and recharge the host electronic device 10. The integrated wireless charger 138 includes an internal inductive electromagnet 140 and an electromagnetic transfuser 142 housed within the base section 130. The internal inductive electromagnet 140 is formed by a closed loop of magnetic copper coil in tightly-wound format. The extending gripping socket system 100 may include a method of mechanical energy generation, such as but not limited to creation of kinetic energy upon collapse and extension of the extending gripping socket 110.

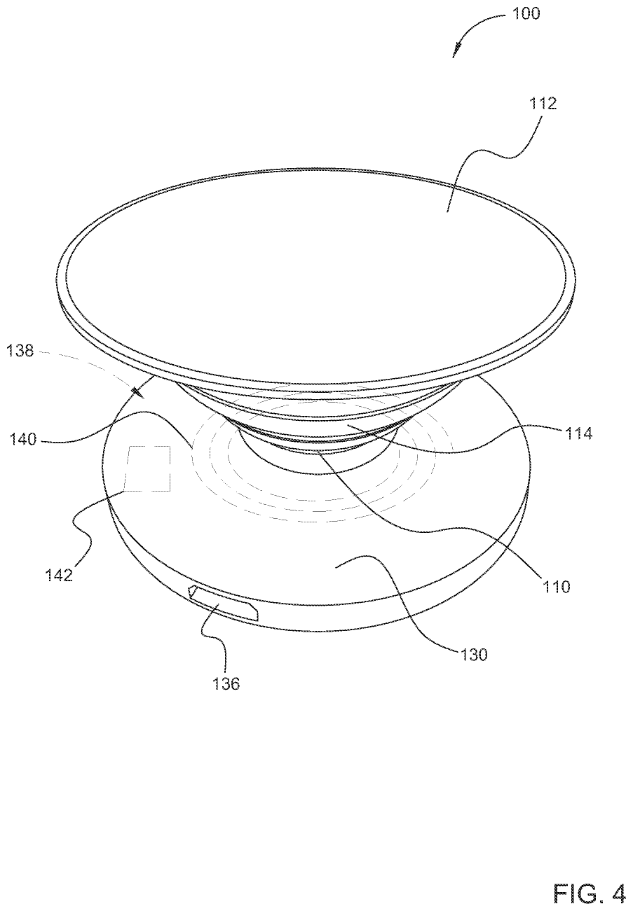

FIG. 4 is a perspective view of the extending gripping socket system 100 of FIG. 1 in an extended condition, according to an embodiment of the present disclosure. As shown in the FIGS., the extending gripping socket 110 comprises an accordion-style body 114. The extending gripping socket 110 includes a flat gripping member 112 at an endpoint opposing the base section 130. The flat gripping member 112 may include indicia. The extending gripping socket 110 is semi-rigid and is tapered towards the base section 130. Walls of the extending gripping socket 110 are configured to fold towards the base section 130 when the extending gripping socket 110 is being retracted. The extending gripping socket 110 can be gripped multiple ways and reduces a risk of dropping host electronic devices 10 while held. Additionally, the extending gripping socket 110 may also be used to prop a host electronic device 10 in a desirable upright position as needed.

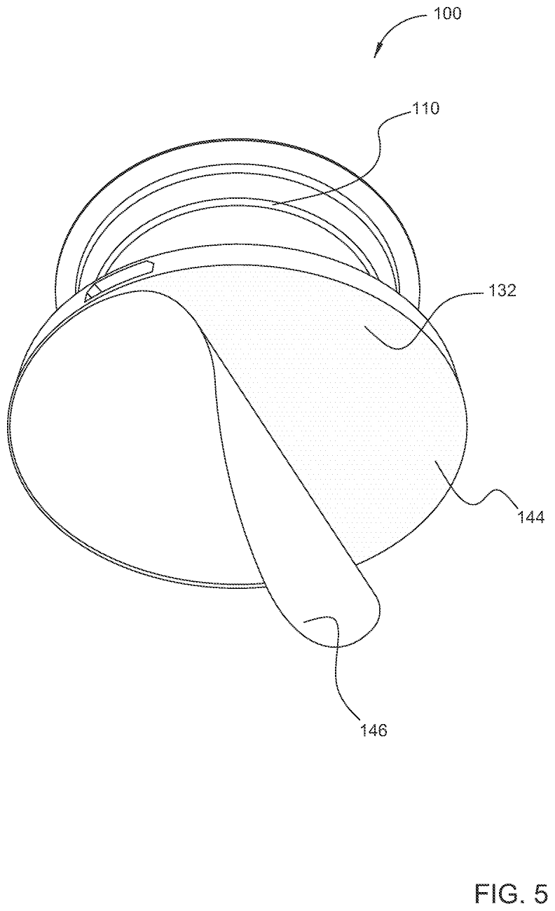

FIG. 5 is a bottom perspective view of the extending gripping socket system 100 of FIG. 1, according to an embodiment of the present disclosure. The extending gripping socket system 100 includes the extending gripping socket 110 attached to the base section 130. The base section 130 includes the fastener section 132 positioned on a bottom plane 144 of the base section 130 which is configured to secure the extending gripping socket system 100 to a host electronic device 10. The extending gripping socket 110 is removable from the host electronic device 10. In a preferred embodiment, the fastener section 132 includes an adhesive fastener. The adhesive fastener comprises a layer of pressure-sensitive adhesive. As shown, the adhesive section includes a removeable cover 146 configured to be removed and expose the pressure-sensitive adhesive for application of the extending gripping socket system 100. In other embodiments, the fastener section 132 includes a suction cup fastener.

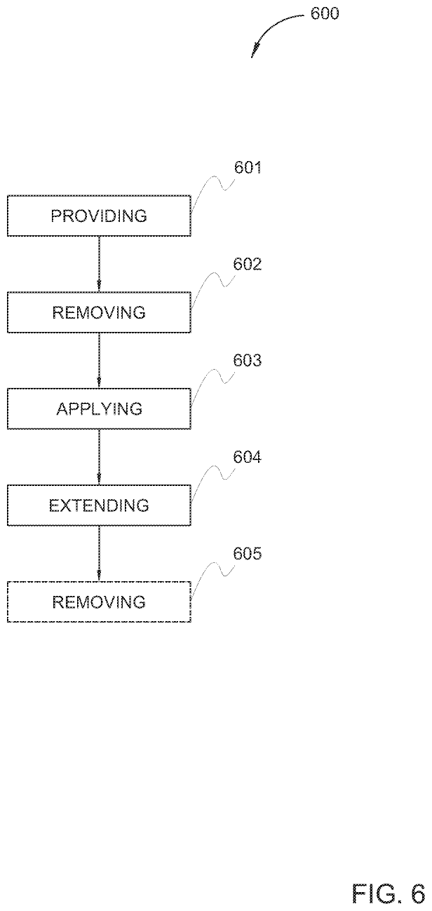

FIG. 6 is a flow diagram illustrating a method of use, according to an embodiment of the present disclosure. In particular, the method of use 600 may include one or more components or features of the extending gripping socket system 100 as described above. As illustrated, the method of use 600 may include the steps of: step one 601, providing an extending gripping socket system 100 including an extending gripping socket 110 having a semi-conical shape and being configured to extend and retract in relation to a base section 130 having a fastener section 132 positioned on a bottom plane 144 of the base section 130 which is configured to secure the extending gripping socket system 100 to a host electronic device 10, an integrated wireless charger 138 configured to provide power to and recharge the host electronic device 10, and a charging port 136; step two 602, removing a removeable cover 146; step three 603, applying the fastener section 132 to the host electronic device 10; step four 604, extending the extending gripping socket 110 for gripping; and step five 605, removing the extending gripping socket system 100 from the host electronic device 10.

It should be noted that step five 605 is an optional step and may not be implemented in all cases. Optional steps of method of use 600 are illustrated using dotted lines in FIG. 6 so as to distinguish them from the other steps of method of use 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the extending gripping socket system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An extending gripping socket system, said extending gripping socket system comprising:
an extending gripping socket having a semi-conical shape and being configured to extend and retract in relation to a base section having,
a fastener section positioned on a bottom plane of said base section which is configured to secure said extending gripping socket system to a host electronic device,
an integrated wireless charger configured to provide power to and recharge said host electronic device, and
a charging port, and
wherein said extending gripping socket system provides an extendable hand grip for assisting a user with gripping and securely holding said host electronic device during use.

2. The extending gripping socket system of claim 1, wherein said integrated wireless charger includes an internal inductive electromagnet and an electromagnetic transfuser housed within said base section.

3. The extending gripping socket system of claim 2, wherein said internal inductive electromagnet is formed by a closed loop of magnetic copper coil in tightly-wound format.

4. The extending gripping socket system of claim 1, wherein said fastener section includes an adhesive fastener.

5. The extending gripping socket system of claim 4, wherein said adhesive fastener includes a layer of pressure-sensitive adhesive.

6. The extending gripping socket system of claim 5, wherein said adhesive section includes a removeable cover configured to be removed and expose said pressure-sensitive adhesive for application of said extending gripping socket system.

7. The extending gripping socket system of claim 1, wherein said fastener section includes a suction cup fastener.

8. The extending gripping socket system of claim 1, wherein said extending gripping socket comprises an accordion-style body.

9. The extending gripping socket system of claim 8, wherein said extending gripping socket includes a flat gripping member at an endpoint opposing said base section.

10. The extending gripping socket system of claim 9, wherein said flat gripping member includes indicia.

11. The extending gripping socket system of claim 1, wherein said host electronic device is a smartphone.

12. The extending gripping socket system of claim 1, wherein said extending gripping socket is removable from said host electronic device.

13. The extending gripping socket system of claim 1, wherein said extending gripping socket is tapered towards said base section.

14. The extending gripping socket system of claim 13, wherein walls of said extending gripping socket are configured to fold towards said base section when said extending gripping socket is being retracted.

15. The extending gripping socket system of claim 14, wherein said extending gripping socket is semi-rigid.

16. The extending gripping socket system of claim 1, further includes a solar panel providing power to said integrated wireless charger.

17. The extending gripping socket system of claim 1, wherein said extending gripping socket system is provided as a phone case having an integrated said extending gripping socket and said integrated wireless charger.

18. An extending gripping socket system, said extending gripping socket system comprising:
an extending gripping socket having a semi-conical shape and being configured to extend and retract in relation to a base section having,
a fastener section positioned on a bottom plane of said base section which is configured to secure said extending gripping socket system to a host electronic device,
an integrated wireless charger configured to provide power to and recharge said host electronic device, and
a charging port,
wherein said extending gripping socket system provides an extendable hand grip for assisting a user with gripping and securely holding said host electronic device during use;
wherein said integrated wireless charger includes an internal inductive electromagnet and an electromagnetic transfuser housed within said base section;
wherein said internal inductive electromagnet is formed by a closed loop of magnetic copper coil in tightly-wound format;
wherein said fastener section includes an adhesive fastener;
wherein said adhesive fastener includes a layer of pressure-sensitive adhesive;
wherein said adhesive section includes a removeable cover configured to be removed and expose said pressure-sensitive adhesive for application of said extending gripping socket system;
wherein said extending gripping socket comprises an accordion-style body;
wherein said extending gripping socket includes a flat gripping member at an endpoint opposing said base section;
wherein said flat gripping member includes indicia;
wherein said extending gripping socket is tapered towards said base section;
wherein walls of said extending gripping socket are configured to fold towards said base section when said extending gripping socket is being retracted;
wherein said extending gripping socket is semi-rigid;
wherein said host electronic device is a smartphone; and
wherein said extending gripping socket is removable from said host electronic device.

19. A method of using an extending gripping socket system, the method comprising the steps of:
providing an extending gripping socket system including an extending gripping socket having a semi-conical shape and being configured to extend and retract in relation to a base section having,
a fastener section positioned on a bottom plane of said base section which is configured to secure said extending gripping socket system to a host electronic device,
an integrated wireless charger configured to provide power to and recharge said host electronic device,
a charging port,
removing a removeable cover,
applying said fastener section to said host electronic device, and
extending said extending gripping socket for gripping.

20. The method of claim 19, further comprising the step of:
removing said extending gripping socket system from said host electronic device.
